(19) United States
(12) Patent Application Publication
(10) Pub. No.: US 2006/0208706 A1
(43) Pub. Date: Sep. 21, 2006

(54) Device for switching battery units

(75) Inventors: Rick Hsu, Taipei (TW); Fancy Zhang, Shanghai (CN)

Correspondence Address: PEARL COHEN ZEDEK, LLP, 1500 BROADWAY 12TH FLOOR, NEW YORK, NY, 10036, US

(73) Assignee: INVENTEC CORPORATION

(21) Appl. No.: 11/079,110

(22) Filed: Mar. 15, 2005

(51) Int. Cl. H02J 7/04

(52) U.S. Cl. 320/149

(57) ABSTRACT

A device for switching battery units applicable to an electronic device having a plurality of battery units for power supply is proposed. The device determines a charging/discharging sequence for the battery units before performing a charge or discharge operation. That is, the device performs not only charge or discharge operation based on the original arrangement for the battery unit, but also adjusts charging/discharging sequence among a plurality of battery units according to the practical requirement, so as to increase or decrease the electricity volume of the selected battery unit. Therefore, the selected battery units can be increased or decreased for electricity volume without waiting for charging/discharging of other battery units to stop, when certain battery units are to be charged or discharged. Accordingly, this minimizes the time wasted on waiting for charging/discharging of other battery units.

### FIELD OF THE INVENTION

The present invention relates to a battery volume management technique, and more specifically, to a device for switching battery units applicable to switch charging/discharging sequence for a plurality of battery units contained in an electronic device, so as to shorten the time spent on performing the charge or discharge operation of the battery units.

### BACKGROUND OF THE INVENTION

At the present time, computers have been widely used, with a continuous improvement in computer quality in accordance with ever-lasting technical breakthroughs, making the computers to operate faster and faster. And the computers, such as laptop computers and notebook computer are also made more and more compact to enhance portability thereof.

As the Notebook computer is carried around to the outdoor by a user, a battery unit that comes with the notebook computer is the only source of power supply that the notebook computer can rely on due to a lack of external power supply in the outdoor environment, making the battery unit very importance to the notebook computer.

Therefore, many notebook computers are equipped with two battery units to solve the problem of power supply shortage. However, a Basic Input/Output System (BIOS) is configured to preset a predetermined charging/discharging sequence in the conventional notebook computer equipped with two battery units. A conventional preset charging/discharging sequence involves firstly discharging a primary battery unit, followed by discharging a secondary battery unit. Alternatively, the primary battery unit is charged before charging the secondary battery unit. However, it is still inconvenient for the conventional preset charging/discharging sequence regardless of which charge or discharge sequence is preset. For example, if the BIOS is preset with a sequence of firstly charging the primary battery unit, the secondary battery unit can only be charged or discharged subsequently after the primary battery unit is fully charged (usually takes around 1-2 hours) or disassembled, which is very inconvenience for the user, and brings a lot of extra burdens and unnecessary troubles to the user.

Consequently, it is a problem to be solved herein for developing a technique to flexibly switch the charging/discharging sequence of the battery units according to practical requirement.

### SUMMARY OF THE INVENTION

In light of the drawbacks associated with conventional technologies, an objective of the present invention is to provide a device for switching battery units applicable to preset the sequence of increasing or decreasing the electricity volumes of the battery units according to practical need of an user.

Another objective of the present invention is to provide a device for switching battery units, which can be employed to firstly increasing of decreasing the electricity volume of a selected battery unit according to practical need of the user, for shortening the time required for fully charging or discharging the battery units, so as to further enhance an operating efficiency of increasing or decreasing the electricity volume of the battery units.

In accordance with the above and other objectives, the present invention proposes a device for switching battery units.

The device for switching battery units at least comprises: (1) a controlling module for determining the sequence of increasing or decreasing the electricity volume of the battery units, and sending a driving command signal; (2) a determining module for receiving the driving command signal from the control module, determining whether an external power is supplied or not, and sending a charge signal when there is the external power supply, otherwise sending a discharge signal; (3) a sequence changing module for performing increasing or decreasing electricity volume operation to the battery unit according to the preset charging/discharging sequence and the determination result of the determine module; and (4) electricity volume increasing or decreasing module for charging or discharging the battery unit so as to modify the electricity volume thereof.

By comparing with the conventional battery electricity volume management technology, the device for switching battery units not only performs charge or discharge operation for the battery units, but also flexibly changes the charging/discharging sequence among a plurality of battery units according to the practical need of the user. Therefore, this minimizes the operation time required for increasing or decreasing the electricity volume, and facilitates electricity volume management and operation to the battery units for the user.

The present invention is described in the following with specific embodiments, so that one skilled in the pertinent art can easily understand other advantages and effects of the present invention from the disclosure of the invention. The present invention is also implemented and applied according to other embodiments, and details are modified based on different views and applications without departing from the spirit of the invention.

### BRIEF DESCRIPTION OF THE DRAWINGS

FIG. 1 is a block diagram illustrating a basic construction of a device for switching battery units in accordance with a preferred embodiment of the present invention;

FIG. 2 is a flow chart illustrating operation of the device for switching battery units in accordance with the preferred embodiment of the present invention; and

FIG. 3A through to FIG. 3D are schematic diagrams illustrating the sequence of increasing of decreasing the electricity volume of the battery units in accordance with the preferred embodiment of the present invention.

### DETAILED DESCRIPTION OF THE PREFERRED EMBODIMENTS

The present invention is described in the following with specific embodiments, so that one skilled in the pertinent art can easily understand other advantages and effects of the present invention from the disclosure of the invention. The present invention is also implemented and applied according to other embodiments, and details are modified based on different views and applications without departing from the spirit of the invention.

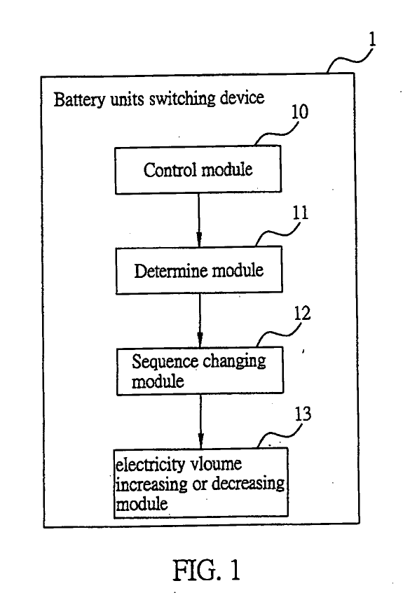

Referring to FIG. 1, a basic construction of the device for switching battery units in accordance with the preferred embodiment of the present invention is shown. The device 1 is employed in an electronic device (such as notebook computer, digital camera or PDA), and comprises a controlling module 10, a determining module 11, a sequence changing module 12 and an electricity volume increasing or decreasing module 13. The controlling module 10 sends a driving command signal according to a sequence of increasing of decreasing the electricity volume of the battery units preset by a user, that is, when the user performs charge or discharge operation to a plurality of battery units of the electronic device, the controlling module 10 can be employed to send a driving command signal via a hot key.

The determining module 11 is employed to receive the driving command signal from the control module 10, and determine whether an external power is supplied or not, for determining the charge or discharge operation of the battery units.

The sequence changing module 12 is employed to determine the charging/discharging sequence of a plurality of battery units according to the determine result of the determine module 11, send a confirmation signal.

The electricity volume increasing or decreasing module 13 is employed to perform charge or discharge operation to the battery units according to the confirmation signal from the sequence changing module 12.

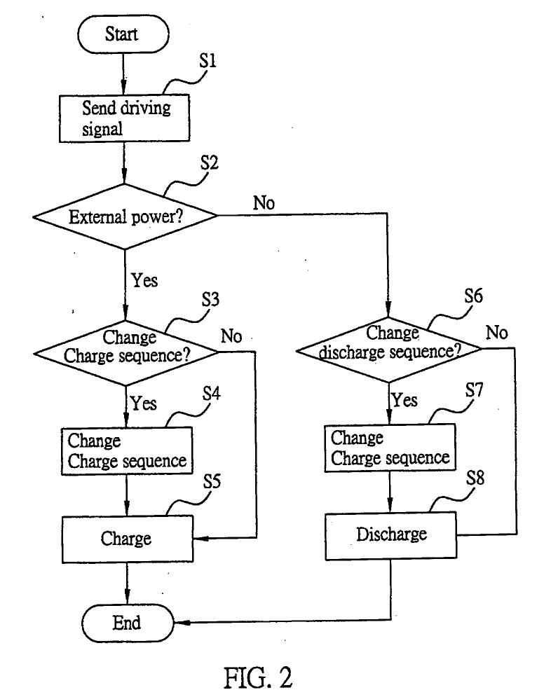

Referring to FIG. 2, a flow chart illustrating operation of the battery units switching device in accordance with the preferred embodiment of the present invention is shown.

Firstly, step S1 is executed, wherein the controlling module 10 is employed to send a driving command signal which drives the battery units to perform charge of discharge operation, and the user presses the hot key of the control module 10 a number of times to change the sequence of charge or discharge of the battery units, for example, as the hot key is pressed once, the controlling module 10 sends a signal of maintaining the original charge or discharged sequence. And if the hot key is pressed a certain number of times, the controlling module 10 sends a charge or discharge signal to a battery unit corresponding to the certain number, before proceeding to step S2.

In step S2, the determining module 11 is employed to determine whether an external power is supplied or not. If there is the external power supply, step S3 is executed to perform charge operation; otherwise step S6 is executed to perform discharge operation.

In step S3, the number of times the hot key is pressed is calculated to determine whether to change the charge sequence or not. If the charge sequence is to be changed, step S4 is executed; otherwise step S5 is executed.

In step S4, the charge sequence of the battery units is changed according to the signal from the controlling module 10, the charge operation to the battery unit corresponding to the number of times the hot key pressed is performed, while the charge sequence of the other battery units is kept unchanged before proceeding to step S5.

In step S5, the charge operation to the battery unit is performed via the electricity increasing or decreasing module 13 connecting to the external power supply.

In step S6, a determination is made as whether to change the discharge sequence of the battery units or not according to the number of times of the hot key pressed, if the discharge sequence is to be changed, step S7 is executed; otherwise step S8 is executed.

In step S7, the discharge sequence of the battery unit is changed according to the signal from the controlling module 10, and the discharge operation to the battery unit corresponding to the number of times the hot key pressed is performed, while the discharge sequence for the other battery units is kept unchanged before proceeding to step S8.

In step S8, performing discharge operation to the battery unit via the electricity increasing or decreasing module 13.

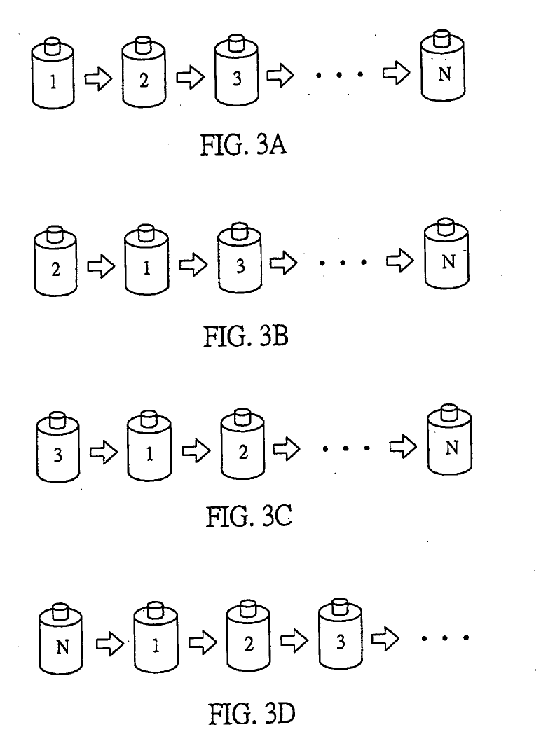

Referring to FIG. 3A to FIG. 3D, the sequences of performing charge or discharge operation to the battery units of step S4 and step S7 are described in further details. In case when the user wants to increase of decrease the electricity volume of the battery units, but does not want to change the charge or discharge sequence of the battery units, the hot key is pressed once; and when the user wants to perform charge or discharge operation to the second battery unit, the hot key is pressed two times; in case of the user want to perform charge of discharge operation to the third battery unit, the hot key is pressed three times. Similarly, if the user want to perform charge or discharge operation to the Nth battery unit, the hot key is pressed N times.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A device for switching battery units applicable to an electronic device having at least a battery unit for power supply, for switching a sequence of increasing/decreasing electricity volume of the battery unit, the device comprising:
a controlling module, for presetting the sequence of increasing/decreasing the electricity volume of the battery unit, and issuing a driving command signal;
a determining module, for receiving the driving command signal and determining whether an external power is input or not, and a first signal is input when the external power is input, otherwise a second signal is input; and
a sequence changing module, for performing an electricity volume modifying operation to the battery unit according to the preset sequence of increasing/decreasing the electricity volume of the battery unit and the determination result of the determining module.

2. The device as claimed in claim 1, wherein the controlling module is an operating interface.

3. The device as claimed in claim 2, wherein the operating interface includes a plurality of keys of a keyboard.

4. The device as claimed in claim 1, wherein the electronic device is one selected from a group consisting of notebook computer, digital camera, and PDA.

5. The device as claimed in claim 1, wherein the determining module determines the sequence of increasing or decreasing the electricity volume of the battery unit according to the number of times the keys are pressed by the user.

6. The device as claimed in claim 1, wherein the first signal is a charge command, for inputting the external power to the battery unit, so as to perform a charge operation for the battery unit.

7. The device as claimed in claim 1, wherein the second signal is a discharge command for performing a discharge operation by the battery unit contained in the electronic device.

8. The device as claimed in claim 1, wherein determining module selects the battery unit to be modified for electricity volume according to the number of times hot keys are pressed.

9. The device as claimed in claim 8, wherein the electricity volume modification is one of the operations for charging and discharging the battery unit.
